(19) United States
(12) Patent Application Publication
(10) Pub. No.: US 2001/0027529 A1
(43) Pub. Date: Oct. 4, 2001

(54) Authentication device, authentication method, program storage medium and information processing device

(76) Inventors: Yuichiro Sasabe, Kanagawa (JP); Yoshihiro Yamaguchi, Tokyo (JP); Junichiro Sakata, Tokyo (JP); Yuichiro Ishii, Tokyo (JP)

Correspondence Address: William S. Frommer, Esq., FROMMER LAWRENCE & HAUG LLP, 745 Fifth Avenue, New York, NY, 10151, US

(21) Appl. No.: 09/771,324

(22) Filed: Jan. 26, 2001

(30) Foreign Application Priority Data
Jan. 28, 2000 (JP) P2000-024800

(51) Int. Cl. G06F 12/14; H04L 9/00; H04L 9/32; G06F 11/30

(52) U.S. Cl. 713/202; 713/200

(57) ABSTRACT

An authentication device and an authentication method, a program storage medium and an information processing device improve the operability in the user authentication. By comparing the dial password entered by the rotation operation of the jog dial and the dial password registered in advance and conducting the user authentication, the user can enter the dial password intuitively and easily just by operating the jog dial and can make the user authentication be executed.

### BACKGROUND OF THE INVENTION

1. Field of the Invention

The present invention relates to an authentication device and an authentication method, a program storage medium and an information processing device, and more particularly, is suitably applied to such as a personal computer.

2. Description of the Related Art

Heretofore, in the information processing device such as the personal computer, the user authentication method by means of password has been widely used as the method to authenticate the justice of user.

In this information processing device using the user authentication method by means of password, for example, the user is requested to enter his password at the time when starting up the processing. And only when the password entered agrees with the password registered in advance, it is judged that the operation is conducted by the justifiable user and the usage of the information processing device will be accepted.

However, in the information processing device using the user authentication method by password, it has created a problem that the operation was complicated and difficult for the user who was not accustomed to operating the keyboard since the user had to enter the password by operating keyboard.

Moreover, in the information processing device using the user authentication method by password, since there are cases in which the short password would be encrypted by random trials and guesses, a series of long characters must be used to prevent the encryption. And this has caused a problem that the password was difficult to be memorized by the user.

### SUMMARY OF THE INVENTION

In view of the foregoing, an object of the invention is to provide an authentication device, a authentication method, a program storage medium and an information processing device capable of conducting the user authentication by the simple operation.

The foregoing object and other objects of the invention have been achieved by the provision of an authentication device which comprises an input means for entering the operation pattern information according to the rotation operation of the predetermined operation key and a control means for authenticating only when the operation pattern information entered by the input means agrees with the operation pattern information registered in advance in the predetermined memory means and for executing the predetermined processing. Accordingly, the user can enter the operation pattern information easily and intuitively only by rotation operating the operation key. And thus, the authentication processing can be executed with simple operation.

The nature, principle and utility of the invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is a brief linear sketch showing the general construction of a notebook PC equipped with a jog dial according to the present invention;

FIG. 2 is a brief linear sketch showing the construction of the left side surface of the main unit;

FIG. 3 is a brief linear sketch showing the construction of the rear side surface and the bottom surface of the main unit;

FIG. 4 is a brief linear sketch showing the external view of the jog dial attached to the main unit;

FIG. 5 is a block diagram showing the circuit construction of a notebook PC attached with a jog dial;

FIGS. 6A and 6B are brief linear sketches showing the construction of screen lock screen;

FIG. 7 is a flow chart showing the construction of the dial password setting screen;

FIG. 8 is a brief linear diagram showing the construction of the dial password setting screen;

FIG. 9 is a brief linear diagram showing the construction of the password setting screen for emergency avoidance;

FIG. 10 is a flow chart showing the dial password authentication procedure; and

FIG. 11 is a brief linear diagram showing the construction of the password input screen for emergency avoidance.

### DETAILED DESCRIPTION OF THE EMBODIMENT

Preferred embodiments of this invention will be described with reference to the accompanying drawings:

(1) Construction of Notebook-Sized Personal Computer Attached with Jog Dial

(1-1) General Construction of Notebook PC Attached with Jog Dial

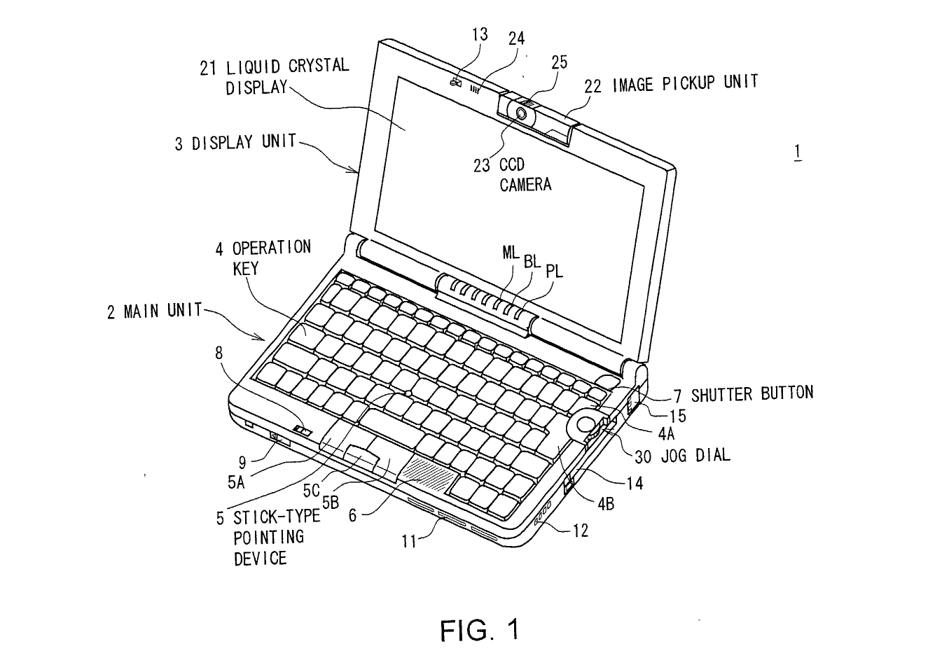

In FIG. 1, 1 generally shows a notebook-sized personal computer attached with a jog dial (hereinafter referred to as notebook PC) as an information processing device, and this is comprised of a main unit 2 and a display unit 3 attached open/close-free to the main unit 2.

On the top surface of the main unit 2, the plural number of operation keys 4 for entering various characters, symbols and numbers, a stick-type pointing device (hereinafter referred to as only stick) 5 which is used for moving the mouse cursor, a left click button 5A and a right click button 5B which are equivalent to the left button and the right button of the normal mouse, a center button 5C for operating the scroll bar without matching the mouse cursor to the scroll button, a built-in speaker 6, and a shutter button 7 for a Charge Coupled Device (CCD) camera 23 provided on the display unit 3 are provided.

A Liquid Crystal Display (LCD) display 21 is provided on front surface of the display unit 3, and at the center upper edge part, an image pickup unit 22 having a CCD camera 23 is attached to the display unit 3 rotation-free.

More specifically, the image pickup unit 22 rotates within the angle range of 180° between the front direction and the rear direction of the display unit 3 and positioning can be obtained at the optional position within the angle range. Moreover, the image pickup unit 22 is equipped with an adjusting ring 25 to conduct the focus adjustment of the CCD camera 23, and the focus adjustment in the case of photographing the desired subject to be photographed by the CCD camera 23 can be easily conducted by rotation operating the adjusting ring 25.

Furthermore, in the display unit 3, a microphone 24 is provided on the left side of the image pickup unit 22, and sounds can be collected from the rear side of the display unit 3 via the microphone 24.

Furthermore, in the display unit 3, a hook 13 is provided on the left side of the microphone 24 and also a hole 8 is provided on the predetermined position of the main unit 2 corresponding to the hook 13. And under the condition in which the display unit 3 is closed to the main unit 2 the hook 13 fits into the hole 8 and locked.

A slide lever 9 is provided on the front side surface of the main unit 2, and by sliding the slide lever 9, the hook 13 fit into the hole 8 is released and thus making the display unit 3 can be opened to the main unit 2. Moreover, multiple aspiration inlets 11 are provided on the front side surface of the main unit 2.

Furthermore, on the right side surface of the main unit 2, a ventilation outlet 12, a PC card slot 14 compatible with the Personal Computer Memory Card International Association (PCMCIA) standard Personal Computer (PC) card and a modem terminal for modular jack 15 are provided.

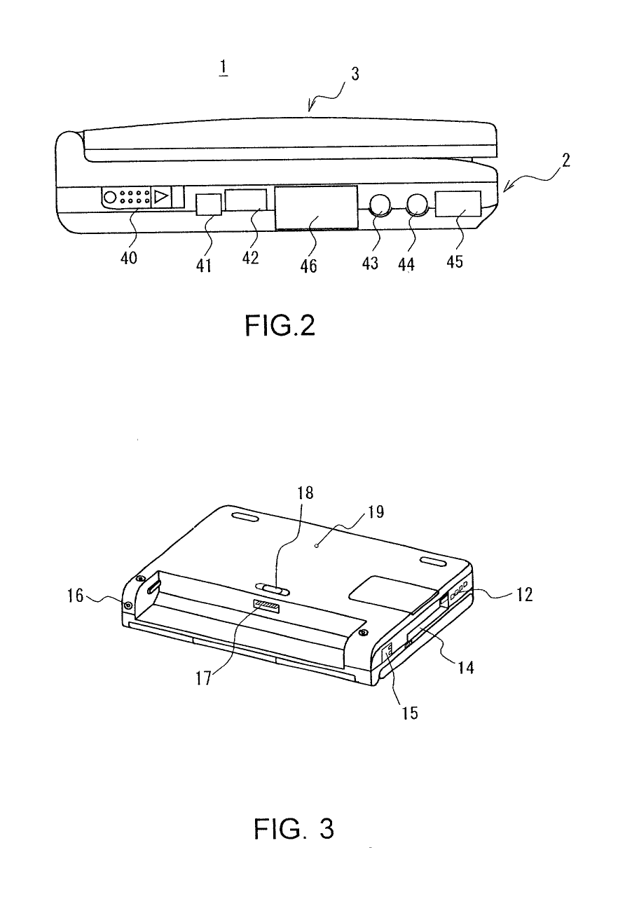

On the other hand, as shown in FIG. 2, on the left side surface of the main unit 2, a sliding power switch 40, a 4-pin capable Institute of Electrical and Electronics Engineers (IEEE) 1394 terminal 41, a Universal Serial Bus (USB) terminal 42, a connector for external display 46, an input terminal for microphone 43, a headphone terminal 44 and an infrared port 45 compliant with the Infrared Data Association (IrDA) are provided.

Furthermore, as shown in FIG. 3, an external power source connector 16 is provided on the rear side surface of the main unit 2. And on the bottom surface of the main unit 2, a sliding type removing lever 18 for removing the battery pack (not shown in FIG.) and a reset switch 19 for temporarily stopping the operation and reconstructing the environment when the power source is put on are provided. In this connection, the battery pack is connected removable-free to the battery connector 17.

In addition to such construction, a jog dial 30 is mounted into between an operation key 4A which is equivalent to the back space key and an operation key 4B which is equivalent to the enter key on the right edge of the upper surface of the main unit 2 (FIG. 1) to become the same height as the operation keys 4A and 4B.

Here, the jog dial 30 is an user interface having excellent operability capable of easily realizing various functions in the system setting and various application softwares by rotation operating and press operating the dial.

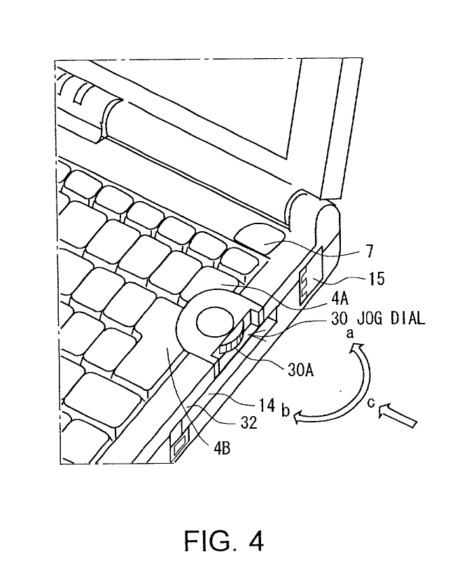

As shown in FIG. 4, this jog dial 30 is attached in a state in which a disc operation knob 218 having plain groove pattern is slightly protruded from the outside case 32 of the main unit 2. This jog dial 20 executes the predetermined processing corresponding to the rotation operation by the disc-shape operation knob 30A in the arrow a direction and the arrow b direction, and conducts the predetermined processing corresponding to the press operation in the arrow c direction.

In this connection, in the disc operation knob 30A, when the user conducts the rotation operation by using this disc operation knob, this knob clicks slightly per the predetermined rotation angle (hereinafter referred to as rotation click) and the user can know the quantity of rotation operation of the disc operation knob 30A by the rotation click through its feeling.

(1-2) Circuit Construction of Notebook PC Attached with Jog Dial

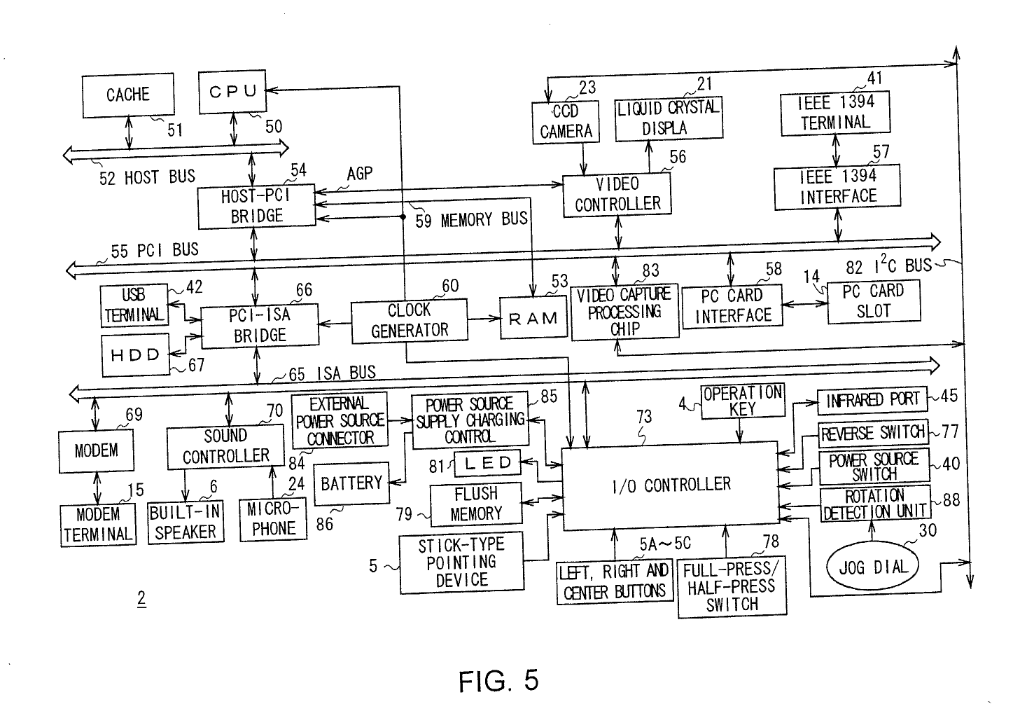

As shown in FIG. 5, in the main unit 2 of the notebook PC 1, the Central Processing Unit (CPU) 50 that totally controls various functions of the main unit 2 is connected to a host bus 52. And by executing the processing according to various programs and application softwares loaded on the Random Access Memory (RAM) 53 by the CPU 50 at the predetermined operation speed based on the system clock to be supplied from the clock generator 60, various functions can be realized.

Furthermore, the host bus 52 is connected with a cache memory 51 and caches data to be used by the CPU 50 and the high speed accessing can be realized.

This host bus 52 is connected to a Peripheral Component Interconnect (PCI) bus 55 via a host-OCI bridge 54, and the PCI bus 55 is connected to a video controller 56, an Institute of Electrical and Electronics Engineers (IEEE) 1394 interface 57, a video capture processing chip 83 and a PC card interface 58.

Here, the host-PCI bridge 5 controls the receptions of various data to be conducted between the CPU 50 and the video controller 56, the video capture processing chip 83, the IEEE 1394 interface 56 and the PC card interface 58 and simultaneously, conducts the memory control of the RAM 53 connected via the memory bus 59.

Furthermore, the host-PCI bridge 54 is connected to the video controller 56 via the signal line along the Accelerated Graphics Port (AGP). And thus, image data can be transmitted at high speed between the host-PCI bridge 54 and th video controller 56.

The video capture processing chip 83 is connected to the I²C bus 82 formed of serial bus (generally called as System Management (SM) bus). And when the image data photographed by the Charge Coupled Device (CCD) camera 23 is supplied through the I²C bus 82, the video capture processing chip 83 stores this once in the built-in frame memory (not shown in FIG. ), and after forming JPEG image data by applying the image compression processing according to the Joint Photographic Experts Group (JPEG) standard, stores the JPEG image data again in the frame memory.

Then, the video capture processing chip 83, after transmitting the JPEG image data stored in the frame memory directly to the RAM 53 using the bus master feature responding to the request from the CPU 50, transmits to the hard disc drive (HDD) 67 as JPEG image (still picture) data or Motion JPEG image (moving picture) data.

The video controller 56, after applying the predetermined graphics processing to the image data photographed by the Charge Coupled Device (CCD) camera 23 and the JPEG image data of the video capture processing chip 83, stores these in the built-in Video Random Access Memory (VRAM) and reads out as occasion demands, and outputting to the liquid crystal display 21, displays these.

Moreover, the video controller 56 is capable of displaying multiple window screens by outputting the image data based on various kinds of application softwares to be supplied as occasion demands.

The PC card interface 58 will be provided as required via the PC card at the time when adding an optional feature, and this can be connected to external devices such as the CD-ROM drive and the DVD drive via the PC card.

The IEEE 1394 interface 57 is directly connected to the IEEE 1394 terminal 41 and also can be connected to external devices such as the other computer device and the digital video camera via the IEEE 1394 terminal 41.

The PCI bus 55 is connected to the Industrial Standard Architecture (ISA) bus 65 via the PCI-ISA bridge 66, and the PCIISA bridge 66 is connected with the HDD 67 and the Universal Serial Bus (USB) terminal 42.

Here, the PCI-ISA bridge 66 comprises an Integrated Drive Electronics (IDE) interface, a configuration register, a Real-Time Clock (RTC) circuit and USB interface, and it controls the HDD 67 via the IDE interface based on the system clock supplied from the clock generator 60.

In the hard disc of the HDD 67, Operating System (OS) such as Window98 (trade mark), electronic mail program, auto-pilot program, capture software, jog dial utility program, jog dial driver, screen lock program and various other application softwares are memorized, and these will be transmitted to the RAM 53 in the process of start processing as occasion demands.

Furthermore, the PCI-ISA bridge 66 controls external devices such as a floppy disc drive, printer and USB mouse (not shown in FIG. ) to be connected via the USB terminal 42 through the USB interface and also controls the modem 69 and the sound controller 70 to be connected to the ISA bus 65.

The modem 69 is connected to an internet service provider (hereinafter referred to as provider) from the modem terminal 15 via the public telephone circuit and Internet (not shown in FIG. ) and accesses between the provider. The sound controller 70 captures audio signal from the microphone 24 and supplies the audio signal to the built-in speaker 6.

Furthermore, an In/Out (I/O) controller 73 is connected to the ISA bus 65 and receives the electric power supply from the external power source connector 84 via the power source supply charging control circuit 85, and it supplies the electric power to each circuit when the power source switch 40 is turned on. Here, the I/O controller 73 also functions based on the system clock to be supplied from the clock generator 60.

Moreover, the power source supply charging control circuit 85 is controlled by the I/O controller 73 and controls the charging of the battery pack 86 connected to the battery connector 17 (FIG. 3).

This I/O controller 73 comprises a micro-controller, an I/O interface, the CPU, ROM and RAM, and controls the input/output of data between the operating system, application softwares and various peripheral equipments such as the liquid crystal display 21 and the HDD 67 based on the Basic Input/Output System (BIOS) stored in the flash memory 79.

This I/O controller 73 is connected to the infrared port 45, and can conduct the infrared communications with such as the other computer device. Moreover, the I/O controller 73 is connected to the reverse switch 77, and when the image pickup unit 22 of the CCD camera 23 is turned 180° in the backward direction of the liquid crystal display 21, the reverse switch 77 is turned on and this will be informed to the CPU 50 via the PCI-ISA bridge 66 and the host-PCI bridge 54.

Furthermore, the I/O controller 73 is connected to the full-press/half-press switch 78. And when the shutter button 7 placed on the top surface of the main unit 2 is put on the half-press condition, the full-press/half-press switch 78 is turned on and the I/O controller 73 informs this to the CPU 50. While, when the shutter button 7 is put on the full-press condition, the full-press/half-press switch 78 is turned on and this will be informed to the CPU 50.

More specifically, when the shutter button 7 is half-pressed by the user while the capture software is started up on the RAM 53 from the hard disc of the HDD 67, the CPU 50 enters the still picture mode and freezes the still picture by controlling the CCD camera 23. And when the shutter button 7 is full-pressed, the CPU 50 captures the still picture data frozen and outputs this to the video controller 56.

On the other hand, when the shutter button 7 is full-pressed by the user while the capture software is not risen, the CPU 50 enters into the moving picture mode and captures the moving picture up to 60 seconds the maximum and outputs this to the video controller 56.

In the ROM of the I/O controller 73, the wakeup program, key input monitor program, LED control program and the jog dial condition monitor program, and various other control programs are stored.

Here, the jog dial condition monitor program is the program related to the jog dial utility program stored in the hard disc of the HDD 67. And this is the program for monitoring whether the jog dial 30 is rotation operated or press operated or not.

The wakeup program is the program controlled by the CPU 50 in order to execute the predetermined processing when the current time to be supplied from the RTC circuit in the PCI-ISA bridge 66 becomes the starting time set in advance. And the key input monitor program is the program to monitor inputs from the operation key 4 and various other key switches.

The LED control program is the program to control the light-up of various lamps formed of Light Emitting Diode (LED) such as the power source lamp PL, the battery lamp BL, the message lamp ML.

Furthermore, the RAM of the I/O controller 73 is equipped with a set time register for wakeup program, a key input monitor register for key input monitor program, a LED control register for LED control program and the I/O register for jog dial condition monitor program and registers for various other programs.

The set time register stores the time information of start time set by the user optionally in advance in order to use in the wakeup program. Accordingly, the I/O controller 73 judges whether the current time to be supplied from the RTC circuit becomes the start time set optionally in advance or not based on the wakeup program. And when the current time becomes the start time, the I/O controller 73 informs this to the CPU 50. Thus, the CPU 50 starts up the predetermined application software set in advance when the start time comes and executes the predetermined processing according to the application software.

The key input monitor register stores operation key flags based on inputs of the operation key 4, the stick 5, the left click button 5A, the right click button 5B and the center button 5C.

Accordingly, the I/O controller 73 judges whether the pointing operation by the stick 5 and the click operations of the left click button 5A, the right click button 5B and the center button 5C are conducted or not based on the key input monitor program according to the condition of operation key flag. And when the pointing operation and the click operation are conducted, the I/O controller 73 informs this to the CPU 50.

Here, the pointing operation is the operation to move the mouse cursor to the desired position by pressing the stick 5 up and down and right and left by the finger. And the click operation is the operation to press the left click button 5A or the right click button 5B rapidly by the finger and release the finger rapidly.

Thus, the CPU 50 executes the predetermined processing corresponding to the movement of a mouse cursor by the pointing operation and the click operation.

The LED control register stores the light-up flag showing the light-up condition of various lamps formed of LED such as the power source lamp PL, the battery lamp BL and the message lamp ML.

Accordingly, when the CPU 50, reading out the electronic mail from the hard disc of the HDD 67, rises this on the RAM 53 by the press operation of the jog dial 30 and receives the electronic mail according to the electronic mail program, the I/O controller 73 stores the light-up flag and simultaneously lights up the message lamp ML by controlling the LED 81 based on the light-up flag.

The I/O register for jog dial condition monitor program stores the rotation operation flag and the press operation flag in response to the rotation operation and the press operation conducted to the jog dial 30.

Accordingly, when the user desired menu item is selected from multiple menu items by the rotation operation and the press operation of the jog dial 30 connected via the rotation detection unit 88, the I/O controller 73 stores the rotation operation flag and the press operation flag into the I/O register and informs this fact to the CPU 50.

Thus, the CPU 50, starting up the application software pertaining to the menu item determined by the rotation operation and the press operation of the jog dial 30 according to the jog dial utility program read out from the HDD 67 and in operation on the RAM 53, executes the predetermined processing.

At this point, the I/O controller 73 constantly operates based on the jog dial condition monitor program by the control of the power source supply charging control circuit 85 even when the power source switch 40 is off and the OS is not started. Thus, the user desired application software and script files can be started even under the power saving condition or when the power source is OFF without providing a key for exclusive use.

Moreover, the I/O controller 73 is connected to the I²C bus 82, and by supplying various kinds of setting parameters to the CCD camera 23 set by the operation key 4 and the jog dial 30 via the I²C bus 82, controls ON/OFF of the camera power source in the CCD camera 23 and adjusts the brightness and contrast of the CCD camera 23.

(2) User Authentication Processing using Jog Dial According to Screen Lock Program

In addition to the construction described above, if the operation input stops for more than the standby time set in advance, the notebook PC 1 judges that the user is not around the notebook PC 1 and displays the predetermined screen saver screen (not shown in FIG. ) on the liquid crystal display 21 (FIG. 1), and conceals the screen display showing the processing contents of the notebook PC 1.

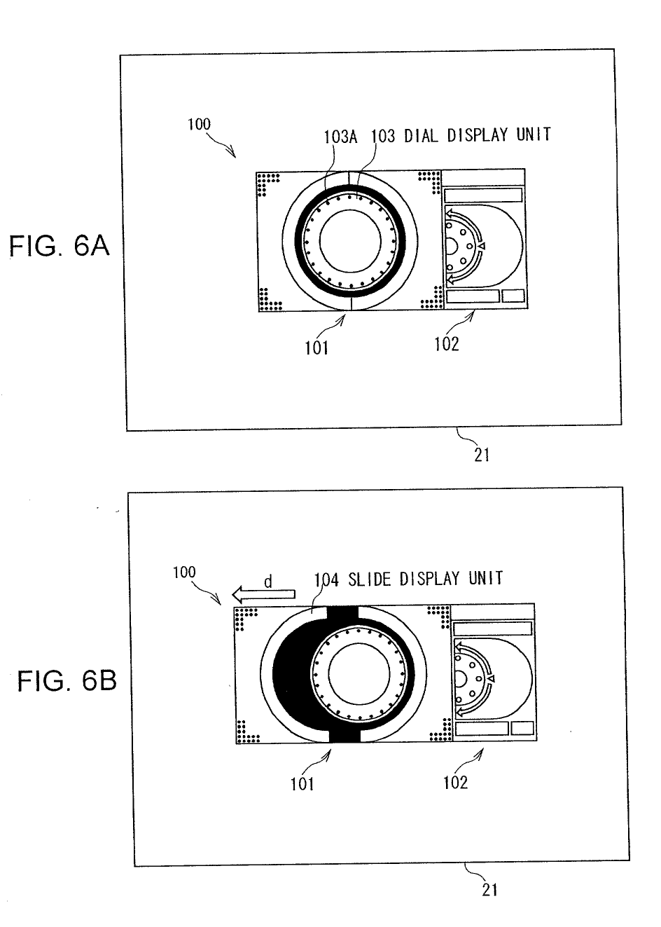

Then, when the notebook PC 1 detects any operation input to the operation key 4 under the condition in which the screen saver screen is displayed, displays a screen lock screen 100 shown in FIG. 6A overlapping on the screen saver screen in the center of liquid crystal display 21.

Under the condition in which this screen lock screen 100 is displayed, the notebook PC 1 compares the rotation operation pattern of the jog dial 30 operated by the user and the rotation operation pattern registered in the notebook PC 1 in advance and conducts the user authentication processing. And when these are in agreement, it judges that the operation input is from the authorized user, and finishing the display of screen saver screen, permits the operation to be followed. And if these are not in agreement, the notebook PC 1 determines that it is not the operation input by the authorized user and continues the display of the screen saver screen. And thus, the operation of the notebook PC 1 by the unauthorized user will be prevented.

Here, the rotation operation pattern is the combined patterns of the number of rotation clicks in the upward direction and the downward direction (e.g., “4-turn click upward, 2-turn click downward, and 1-turn click upward”) when rotation operating the jog dial 30 by moving back and forth between the arrow a direction in FIG. 4 (hereinafter this direction is referred to as the upward direction) and the arrow b direction (hereinafter this direction is referred to as the downward direction) alternately.

Accordingly, in the notebook PC 1, as the password to finish the display of the screen saver screen, the user authentication processing will be conducted using the rotation operation pattern of the jog dial 30 (hereinafter referred to as dial password).

(2-1) Dial Password Registration Processing

Firstly, the registration processing of dial password in the notebook PC 1 will be explained.

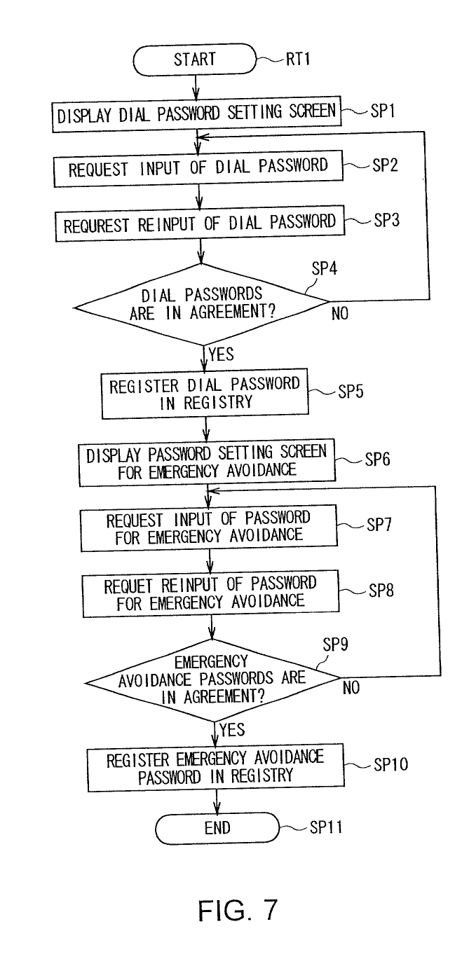

The CPU 50 of the notebook PC 1 reads out the screen lock program from the HDD 67 responding to the predetermined operation by the user and expands this on the RAM 53 and executes the dial password registration processing shown in FIG. 7.

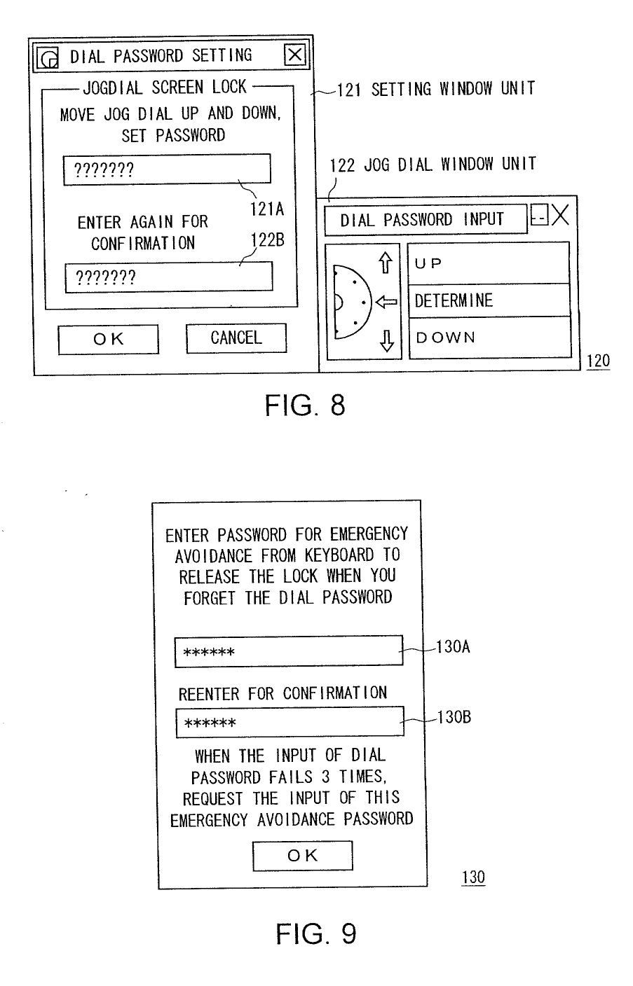

More specifically, the CPU 50 enters from the starting step of the routine RT1 and moves to the step SP1. At the step SP1, the CPU 50 displays a dial password setting screen 120 shown in FIG. 8 on the liquid crystal display 21 and moves to the following step SP2.

As shown in FIG. 8, the dial password setting screen 120 consists of a setting window unit 121 for conducting the setting of dial password, and a jog dial window unit 122 for visually offering the operating condition of jog dial 30 to the user by conducting the display corresponding to the rotation operation and press operation of the jog dial 30.

At the step SP2, the CPU 50 makes the first input area 121A of the setting window unit 121 to the active condition and requests the input of dial password to the user. Under this condition, the user, after rotation operating the jog dial 30 at the optional rotation operation pattern, press operates, and enters the rotation operation pattern as the dial password. Then, CPU 50 moves to the following step SP3 when the dial password is entered.

At the step SP3, CPU 50 activates the second input area 121B of the set window unit 121 and requests a re-enter of the dial password to the user. Under this condition, after rotation operating the jog dial 30 again at an optional rotation operation pattern, the user re-enters the dial password by press operating the jog dial 30. Then, when the dial password is re-entered, CPU 50 moves to the following step SP4.

At the step SP4, CPU 50 judges whether the dial password entered into the first input area 121A coincides with the dial password re-entered into the second input area 121B or not.

If a negative result is obtained at the step SP4, this shows that the dial password entered into the first input area 121A does not agree with the dial password re-entered into the second input area 121B; i.e., this shows that the dial password has not been entered as requested as the user desired rotation operation pattern at the step SP2. And then, CPU 50 returns to the step SP2 and requests the input of dial password again.

On the other hand, in the case where an affirmative result is obtained at the step SP4, this shows that the dial password entered into the first input area 121A agrees with the dial password re-entered into the second input area 121B; i.e., at the step SP2, the dial password has been entered as requested as the user desired rotation operation pattern. And then, CPU 50 moves to the following step SP6.

At the step SP5, the CPU 50 registers the dial password entered into the registry in the HDD 67 and moves to the following step SP6.

At the step SP6, the CPU 50 displays a password setting screen for emergency avoidance 130 (FIG. 9) for setting the password with a series of characters to be used to finish the display of the screen saver screen (hereinafter referred to as an emergency avoidance password) when the user forgets his dial password, and moves to the following step SP7.

At the step SP7, the CPU 50 activates the first input area 130A and requests an input of the emergency avoidance password to the user. Under this condition, the user enters an optional series of characters as the emergency avoidance password by using the operation key 4. Then, when the emergency avoidance password is entered into the first input area 130A, the CPU 50 moves to the following step SP8.

At the step SP8, the CPU 50 activates the second input area 130B and requests the user to re-enter the emergency avoidance password. Then, when the emergency avoidance password is reentered into the second input area 130B, the CPU 50 moves to the following step SP9.

At the step SP9, the CPU 50 judges whether the emergency avoidance password entered into the first input area 130A agrees with the emergency avoidance password re-entered into the second input area 10B or not.

If a negative result is obtained at the step SP9, this shows that the emergency avoidance password entered into the first input area 130A does not agree with the emergency avoidance password reentered into the second input area 130B, i.e., this shows that the emergency avoidance password has not been entered as instructed as the user desired series of characters at the step SP7. And then, the CPU 50 returns to the step SP7, and requests the input of emergency avoidance password again.

On the other hand, if an affirmative result is obtained at the step SP9, this shows that the emergency avoidance password entered into the first input area 130A agrees with the emergency avoidance password re-entered into the second input area 130B; i.e., at the step SP7, the emergency avoidance password has been entered as requested as the user desired character string. And then, the CPU 50 moves to the following step SP10.

At the step SP10, the CPU 50 registers the emergency avoidance password entered into the registry in the HDD 67, and moving to the following step SP11, terminates the processing.

Thus, the notebook PC 1 registers the dial password and the password for emergency avoidance set by the user in the registry in the HDD 67.

In this connection, in the notebook PC 1, the rotation operation of the jog dial 30 in the upward direction is shown by the number “1”, while the rotation operation in the downward direction is shown by the number “0”. And the dial password data expressed by the combination of numbers “1” and “0” corresponding to the number of rotation clicks in the upward and downward directions of the dial password will be encrypted and registered in the registry. For example, when the dial password is “4 rotation clicks in the upward direction, 2 rotation clicks in the downward direction, and furthermore, 1 rotation click in the upward direction”, the dial password data becomes “1111001”.

Furthermore, in the notebook PC 1, after completing the registration of dial password, checking the check box of “protection by password” in the screen saver setting screen (not shown in FIG. ), the user authentication function by the dial password will be made effective.

(2-2) Dial Password Authentication Processing

Next, the authentication processing according to the dial password in the notebook PC 1 will be explained in the following paragraphs.

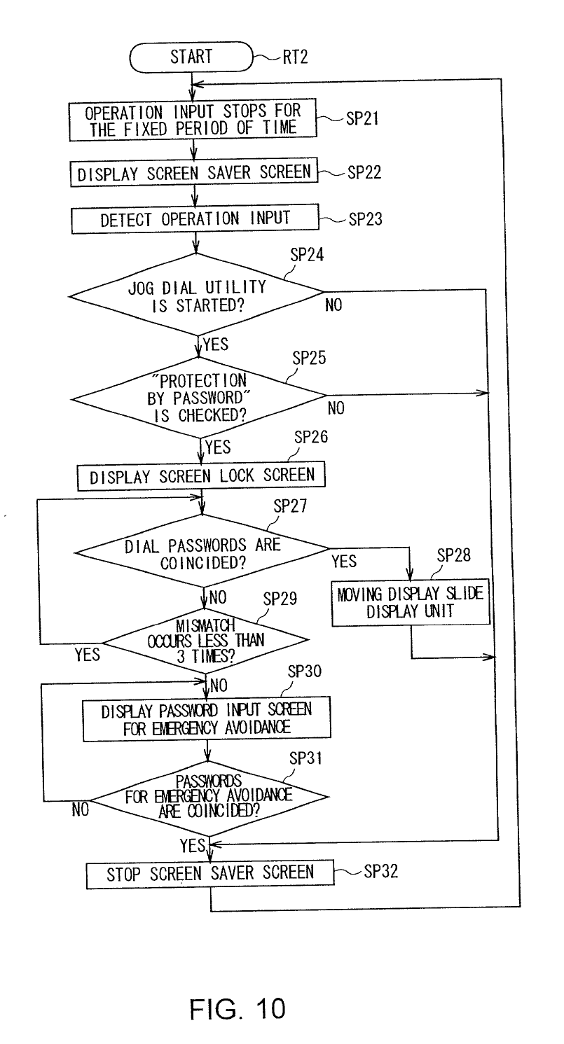

The CPU 50 of the notebook PC 1 executes the dial password authentication procedure according to the screen lock program shown in FIG. 10.

More specifically, the CPU 50 as the control means enters from the starting step of the routine RT2 and moves to the step SP21. At the step SP21, the CPU 50 monitors the operation input by the user via the operation key 4, the stick 5, buttons 5A to 5C, the shutter button 7 or the jog dial 30. And when the operation input is stopped for more than the preset standby time, the CPU 50 moves to the following step SP22.

At the step SP22, the CPU 50 covers the screen display showing the processing contents of the notebook PC 1 by displaying the predetermined screen saver screen on the liquid crystal display 21, and moves to the following step SP23.

At the step SP23, the CPU 50 monitors the operation input by the user, and when the operation input is detected, moves to the following step SP24.

At the step SP24, the CPU 50 judges whether the jog dial utility has been started on the notebook PC 1 or not.

If a negative result is obtained at the step SP24, this means that the jog dial utility has not been started, and the operation of jog dial 30 would not be received. And in this case since the dial password input by the jog dial is impossible, the CPU 50 moves to the step SP32, and after finishing the display of the screen saver screen, returns to the step SP21.

On the other hand, if an affirmative result is obtained at the step SP24, and this means that the jog dial utility is in operation and receiving the operation of jog dial 30. And then, the CPU 50 moves to the following step SP25.

At the step SP25, the CPU 50 judges whether the check box of “protection by password” in the screen saver setting screen is checked or not.

If a negative result is obtained at the step SP25, this means that the check box of “protection by password” has not been checked. And in this case the CPU 50 moves to the step SP32, and after finishing the display of the screen saver screen, returns to the step SP21.

On the other hand, if an affirmative result is obtained at the step SP25, this shows that the check box of the “protection by the password” has been checked, and the CPU 50 moves to the following step SP26.

At the step SP26, the CPU 50 displays a screen lock screen 100 shown in FIG. 6A on the liquid crystal display 21. The screen lock screen 100 consists from a dial lock display unit 101 in which a dial key provided such as in the safe is diagrammatized, and a jog dial window unit 102 that conducts the display according to the rotation operation and the press operation of the jog dial 30.

Under the condition in which this screen lock screen 100 is displayed, the user enters the dial password by rotation operating the jog dial 30 as the input means in the specific rotation operation pattern.

At this point, the CPU 50 rotation displays the dial display unit 103 placed in the center of the dial lock display unit 101 according to the rotation operation of the jog dial 30. And with this arrangement, the visual effects as if the user is actually operating the dial key can be given to the user. Moreover, the plural number of divider marks are provided at regular intervals on the rim of the dial display unit 103. And when the jog dial 30 is turned for one turn click, the CPU 50 rotation displays the dial display unit 103 corresponding this for one divider mark of the divider marks 103A of the dial display unit 103. And thus, the rotation operation of the jog dial 30 can be confirmed visually to the user.

Then, when the jog dial 30 is press operated by the user and the input of dial password is completed, the CPU 50 moves to the following step.

At the step SP27, the CPU 50 judges whether the dial password entered by the user coincides with the dial password registered in the registry or not.

When an affirmative result is obtained at the step SP27, this shows that the dial password entered by the user was in agreement with the dial password registered in the registry, i.e., it shows that the user is the authorized user, and the CPU 50 moves to the step SP28.

At the step SP28, as shown in FIG. 6B, the CPU 50, moving the slide display unit 104 provided on the left side of the dial lock display unit 101 in the arrow d direction, display this. And thus, the visual effects as if actually the dial key is actually opening up can be given to the user.

Then, the CPU 50, upon completing the moving display of the slide display unit 104, moves to the step SP32. And after finishing the display of the screen saver screen, the CPU 50 displays the screen covered again and returns to the step SP21.

On the other hand, in the case where a negative result is obtained at the step SP27, this shows that the dial password entered by the user does not agree with the dial password registered in the registry. Then, the CPU 50 moves to the step SP29.

At the step SP29, the CPU 50 judges whether the number of disagreements of dial passwords in the step SP27 is less than 3 times or not.

If an affirmative result is obtained at the step SP29, this shows that the number of disagreements of dial passwords in the step SP27 is less than 3 times, and the CPU 50 returns to the step SP27.

On the other hand, if a negative result is obtained at the step SP29, this shows that the number of disagreement of dial passwords at the step SP27 is not less than 3 times, and the CPU 50 moves to the following step SP30.

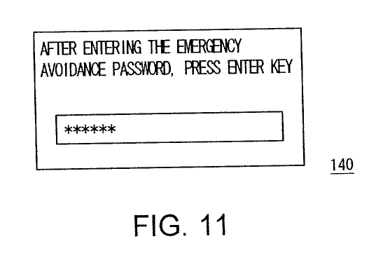

At the step SP30, the CPU 50 displays the password input screen for emergency avoidance 140 shown in FIG. 11 and requests an input of the password for emergency avoidance to the user.

Under the condition in which this emergency avoidance password input screen 140 is displayed, the user enters the password for emergency avoidance by means of operation key 4. Then, when the input of password for emergency avoidance is completed, the CPU 50 moves to the following step SP31.

At the step SP31, the CPU 50 judges whether the password for emergency avoidance entered by the user agrees with the password for emergency avoidance registered into the registry or not.

If a negative result is obtained at the step SP31, this shows that the dial password entered by the user does not agree with the dial password registered in the registry, and the CPU 50 returns to the step SP30.

On the other hand, if an affirmative result is obtained at the step SP31, this shows that the dial password entered by the user agrees with the dial password registered in the registry; i.e., that is the operation by the authorized user. And then, the CPU 50 moves to the step SP32 and after finishing the display of the screen saver screen, returns to the step SP21.

(3) Operation and Effects of the Embodiment

According to the foregoing construction, if the operation input is stopped for more than the standby time set in advance, the notebook PC 1 displays the screen saver screen on the liquid crystal display 21 and covers the screen display showing the processing contents of the notebook PC 1. Then, when the notebook PC 1 detects the operation input to the operation key 4 in a state in which the screen saver screen is displayed, displays the screen lock screen 100 in the center of the screen saver screen and requests the input of dial password to the user.

Then, the notebook PC 1 compares the dial password entered by the rotation operation of the jog dial 30 by the user and the dial password registered in the registry. And when these passwords are not in agreement, the notebook PC 1 determines that the operation input has not been conducted by the authorized user and continues the display of the screen saver screen. And when these passwords are in agreement, it determines that the operation input has been conducted by the authorized user and finishes the display of the screen saver screen.

Accordingly, the user can easily enter the dial password for ending the display of the screen saver screen only by rotation operating the jog dial 30. Moreover, since the dial password is a rotation operation pattern of the jog dial 30, the user can memorize the dial password intuitively and easily.

Furthermore, the notebook PC 1, rotation displaying the dial display unit 103 provided in the center part of the dial lock display unit 101 according to the rotation operation of the jog dial 30 by the user, moving displays the slide display unit 104 provided on the left side of the dial lock display unit 101. Thus, the visual effects as if the user is actually operating the dial key and opening the dial key can be given to the user.

According to the foregoing construction, since in the notebook PC 1 the user authentication is conducted by comparing the dial password entered by the rotation operation of the jog dial 30 and the dial password registered in the registry, the user can memorize and enter the dial password intuitively and easily. And thus, an user interface having the excellent operability for the user can be provided.

Furthermore, since the notebook PC 1 rotation displays the dial display unit 103 according to the rotation operation of the jog dial 30 and moving displays the slide display unit 104 based on the result of user authentication, it can make the user execute the authentication processing intuitively and easily by providing visual effects.

(4) Other Embodiments

The embodiment described above has dealt with the case of conducting the user authentication processing based on the rotation operation pattern of the jog dial 30. However, the present invention is not only limited to this but also the user authentication processing can be conducted based on various other operation patterns, such as the operation pattern of the cursor key (arrow marked keys in the upward, downward, left and right directions), the moving operation pattern of the mouse, or the pressing pattern of the specific key of the keyboard, etc.

Furthermore, the embodiment described above has dealt with the case of using the operation pattern of the rotation operation moving the jog dial 30 in the upward direction and downward direction alternately as the dial password. However, the present invention is not only limited to this but also the user authentication can be conducted by using the operation pattern for rotation operating the jog dial 30 only in the downward direction as the dial password.

Moreover, the embodiment described above has dealt with the case of conducting the user authentication based on the rotation operation of the jog dial 30 and finishing the display of the screen saver screen based on the authentication result. However, the present invention is not only limited to this but also it can be applied to various user authentication processings such as the user authentication processing at the time when the notebook PC 1 is in motion or when the specific application is started.

Furthermore, the embodiment described above has dealt with the case of user authentication processing in the notebook PC 1. However, the present invention is not only limited to this but also it can be applied to the user authentication processing in various devices such as Personal Digital Assistant (PDA): portable data terminal) and the portable telephone equipment.

Moreover, the embodiment described above has dealt with the case of the CPU 50 conducting the user authentication processing by the dial password based on the screen lock program stored in the HDD 67. However, the present invention is not only limited to this but also the user authentication processing can be conducted by installing the recorded program storage medium of the screen lock program.

As described above, the program storage medium that installs the screen lock program to execute a series of user authentication processings into the notebook PC 1 and is used to make it executable condition by the notebook PC 1, can be realize by the semi-conductor memory and the magnetic disc in which programs are temporarily or permanently stored not only by the package media such as the floppy disc, Compact Disk-Read Only Memory (CD-ROM), and the DVD. Moreover, as the means for storing programs in these program storage media, the cabled and wireless communication media such as the local area network and Internet and the digital satellite broadcasting can be utilized or can be stored via various communication interfaces such as the router and modem.

According to the present invention as described above, the user authentication can be conducted just by rotation operating the operation key according to the predetermined operation pattern. And thus, the operability in the user authentication can be further improved.

While there has been described in connection with the preferred embodiments of the invention, it will be obvious to those skilled in the art that various changes and modifications may be aimed, therefore, to cover in the appended claims all such changes and modifications as fall within the true spirit and scope of the invention.

What is claimed is:

1. An authentication device comprising:
an input means for entering operation pattern information corresponding to the predetermined operation of operation key; and
a control means for authenticating only when said operation pattern information entered by said input means agrees with the registered operation pattern information registered in the predetermined memory means in advance and for executing the predetermined processing.

2. The authentication device according to claim 1 wherein said operation key is a jog dial for conducting the rotation operation; and said operation pattern information is the rotation operation pattern information of said jog dial.

3. The authentication device according to claim 2 comprising:
a display means for rotating and displaying the dial display unit displayed on the predetermined display screen according to said rotation operation of the jog dial.

4. An authentication method comprising:
an input step for entering the operation pattern information according to the operation of the predetermined operation key; and
a processing executing step for authenticating only when said operation pattern information entered agrees with the registered operation pattern information registered in the predetermined memory means in advance and for executing the predetermined processing.

5. The authentication method according to claim 4 wherein said operation key is a jog dial for conducting the rotation operation; and said operation pattern information is the rotation operation pattern information of said jog dial.

6. The authentication method according to claim 5 comprising:
a display step for rotating and displaying the dial display unit displayed on the predetermined display screen according to said rotation operation of said jog dial.

7. A program storage medium for making an information processing device execute the program comprising:
an input step for entering operation pattern information according to the operation of the predetermined operation key; and
a processing executing step for authenticating only when said operation pattern information entered agrees with the registered operation pattern information registered in the memory means in advance and for executing the predetermined processing.

8. The program storage medium according to claim 7 wherein said operation key is a jog dial for conducting the rotation operation; and said operation pattern information is the rotation operation pattern information of said jog dial.

9. The program storage medium according to claim 8 comprising:
a display step for rotating and displaying the dial display unit displayed on the predetermined display screen according to said rotation operation of said jog dial.

10. An information processing device comprising:
an input means for supplying input information according to the operation of the predetermined operation key;
a display means for displaying the processing screen according to said input information; and
a display control means for concealing said processing screen when said input information is stopped for more than the fixed time period and for displaying said processing screen again only when the operation pattern information according to the specific operation of said operation key entered via said input means agrees with the registered operation pattern information registered in the predetermined memory means in advance.

11. The information processing device according to claim 10 wherein said operation key is a jog dial for conducting the rotation operation; and said operation pattern information is the rotation operation pattern information of said jog dial.

12. The information processing device according to claim 11 wherein said display means rotates the predetermined dial display unit according to said rotation operation of said jog dial and displays.
